(19) United States
(12) Patent Application Publication
(10) Pub. No.: US 2021/0179381 A1
(43) Pub. Date: Jun. 17, 2021

(54) APPARATUS FOR FEEDING AN UNSTACKER MAGAZINE WITH MAILPIECES ON EDGE

(71) Applicant: SOLYSTIC, Bagneux (FR)

(72) Inventors: Frederic Mestrallet, Etoile sur Rhone (FR); Damien Hugues, Upie (FR); Olivier De Sousa, Montmeyran (FR); Jean Rieu, Saint Georges les Bains (FR)

(21) Appl. No.: 16/070,816

(22) PCT Filed: Jun. 18, 2018
(86) PCT No.: PCT/FR2018/051445

§ 371 Date: Jul. 18, 2018

(30) Foreign Application Priority Data
Aug. 1, 2017 (FR) 1757385

(51) Int. Cl. B65H 31/06; B07C 1/02

(52) U.S. Cl. CPC B65H 31/06; B65H 1/30; B07C 1/025

(57) ABSTRACT

Apparatus (1) for feeding an unstacker magazine (2) with mailpieces (3) on edge, which apparatus includes a first feed conveyor (4) for conveying trays (6) extending crosswise and loaded with mailpieces placed flat on the bottoms of the trays, and tray tipping means (8) for pivoting a tray forwards onto a ramp of the tray tipping means so as to bring the mailpieces on edge from the tray to the unstacker magazine. The apparatus includes a second feed conveyor (5) for conveying trays (6) extending lengthwise and loaded with mailpieces (3) placed on edge on the bottoms of the trays, and tray tipping-over means (9) designed for laying a tray over on its side onto the unstacker magazine.

### TECHNICAL FIELD The invention relates to the field of processing mailpieces at a postal sorting or logistics center.

The invention relates more particularly to apparatus for feeding an unstacker magazine with mailpieces.

### PRIOR ART

Document FR 2 663 915 discloses apparatus specifically designed to feed an unstacker magazine with mailpieces on edge from mailpieces that are sequenced and stacked flat in trays, and that are generally large-format mailpieces.

That apparatus includes a feed conveyor that transports the trays to the unstacker magazine in a certain conveying direction while said trays are in sequence and extend crosswise.

An automated tray tipping system is also provided at a downstream end of the conveyor so as to pivot the trays forwards in the conveying direction onto the unstacker magazine one by one.

The stack of mailpieces stored flat in the tray is thus tipped forwards so that the mailpieces find themselves on edge in the tray.

The tipping system is also arranged to tilt the tray onto the unstacker magazine to an extent sufficient to enable the stack of mailpieces on edge to slide from the tray onto the unstacker magazine.

The mailpieces are thus advantageously oriented on edge and sequenced on the unstacker magazine so as to be moved to the unstacker by an operative using a paddle.

However, that feed apparatus is not adapted for processing mailpieces that are stored on edge in trays.

Trays loaded with mailpieces on edge generally extend lengthwise on the conveyor, thereby preventing them from being tipped by tray tipping means for tipping trays that extend crosswise.

In addition, even if a tray extending lengthwise were tipped forwards, the mailpieces on edge would either be laid flat on the unstacker magazine or would still be on edge but without being sequenced.

This is why the mailpieces stored on edge in the trays are generally processed manually by operatives who, themselves, perform the operation of tipping and of orienting the tray on the unstacker magazine.

Since trays loaded with mailpieces are heavy and voluminous, that tray-handling operation is tiring for operatives.

### SUMMARY OF THE INVENTION

An object of the invention is thus to solve the above-mentioned problems by proposing improved feed apparatus that is capable of feeding an unstacker magazine with mailpieces stored flat and on edge in a workspace that is ergonomically optimized for an operative, while also minimizing the floor area occupied by the apparatus.

To this end, the invention provides apparatus for feeding an unstacker magazine with mailpieces on edge, which apparatus includes a first feed conveyor that extends to said unstacker magazine in a certain conveying direction and that is designed to convey trays extending crosswise and loaded with mailpieces placed flat on the bottoms of the trays, and tray tipping means that are interposed between said first feed conveyor and the magazine and that are designed to pivot a tray forwards in said conveying direction onto a ramp of the tray tipping means so as to bring the mailpieces on edge from the tray to the unstacker magazine, said apparatus being characterized in that it further includes a second feed conveyor that extends to said unstacker magazine and parallel to the first conveyor in said conveying direction and that is designed to convey trays extending lengthwise and loaded with mailpieces placed on edge on the bottoms of the trays, and tray tipping-over means that are interposed between said second feed conveyor and said unstacker magazine and that are designed to lay a tray over on its side onto the unstacker magazine transversely to said conveying direction in such a manner as to bring the mailpieces on edge from the tray to the unstacker magazine, and in that said tipping-over means comprise a ramp on a path intersecting the path of the ramp of the tipping means, said ramps being disposed on two adjacent sides of a stack reconstruction zone in which a stack of mailpieces on edge is reconstructed on said unstacker magazine.

The underlying idea of the invention consists in feeding an unstacker magazine with mailpieces on edge from mailpieces stacked flat or on edge in trays conveyed on two distinct conveyors.

The invention consists in causing the two conveyors to converge by means of tray tipping and tray tipping-over means so as to create a reconstruction zone in which a stack of mailpieces is reconstructed on edge on the unstacker magazine.

Thus, each stack of mailpieces is tipped face-on or side-on, as a function of whether it is oriented flat or on edge in the trays, so as to be oriented on edge and in sequence in the reconstruction zone in which a stack of mailpieces is reconstructed.

The operative is thus positioned facing the stack reconstruction zone so as to retrieve the stack of mailpieces on edge coming from the tipping or tipping-over means.

The tipping-over means also make it possible to process mailpieces that are oriented both in landscape mode and also in portrait mode, also known as “mixed” mailpieces.

Once they have been tipped, mixed mailpieces are still in sequence and they are on edge on another edge, having gone from landscape orientation to portrait orientation and vice versa.

Thus, the operative no longer has to lift trays loaded with mailpieces so as to place them on the unstacker magazine and no longer needs to orient the mailpieces on edge and in sequence on the unstacker magazine.

The apparatus of the invention may advantageously have the following features:
it further includes a tray removal conveyor for removing trays that extends along the first feed conveyor of the unstacker magazine; and
the second tipping means are provided with an abutment at the bottom of the ramp and designed to block the base of a tray and to provide leverage for laying a tray over onto said unstacker magazine.

### BRIEF DESCRIPTION OF THE DRAWINGS

The present invention can be better understood and other advantages appear on reading the following detailed description of an embodiment given by way of non-limiting example and with reference to the accompanying drawings, in which:

FIG. 1 is a diagrammatic perspective view of the apparatus of the invention for feeding an unstacker magazine;

FIGS. 2 and 3 are diagrammatic perspective views of the apparatus of the invention for feeding an unstacker magazine with mailpieces stacked flat in trays on the first conveyor; and

FIG. 4 is a diagrammatic perspective view of the apparatus of the invention for feeding an unstacker magazine with mailpieces stacked on edge in trays on the second conveyor.

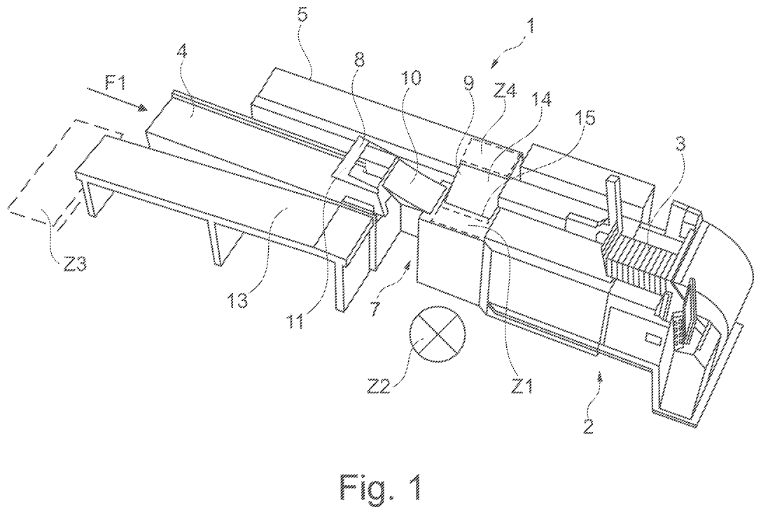

Description of the embodiment The apparatus 1 of the invention as shown in FIG. 1 is particularly adapted for feeding an unstacker magazine 2 with mailpieces 3 in a postal sorting or logistics center.

The term “unstacker magazine” 2 is used to mean a magazine for temporarily storing mailpieces that feeds an unstacker.

The mailpieces 3 that feed the unstacker magazine are generally letters, parcels, etc.

In FIG. 1, the apparatus 1 includes first and second feed conveyors 4, 5 designed to convey trays 6 filled with mailpieces 3 to the unstacker magazine 2 in a certain conveying direction F1.

The two conveyors 4, 5 converge at a downstream end 7 of the unstacker magazine 2 in order to concentrate the feeding with mailpieces 3 on the stacking magazine 2 at a stack reconstruction zone Z1 delimited by dashed lines in FIG. 1 and in which stacks of mailpieces are reconstructed.

The stack reconstruction zone Z1 is advantageously situated in the vicinity of a work zone Z2 in which the operative works.

The first and second conveyors 4, 5 are also terminated respectively by tray tipping means 8 for tipping a tray 6, and tray tipping-over means 9 for tipping a tray 6 over.

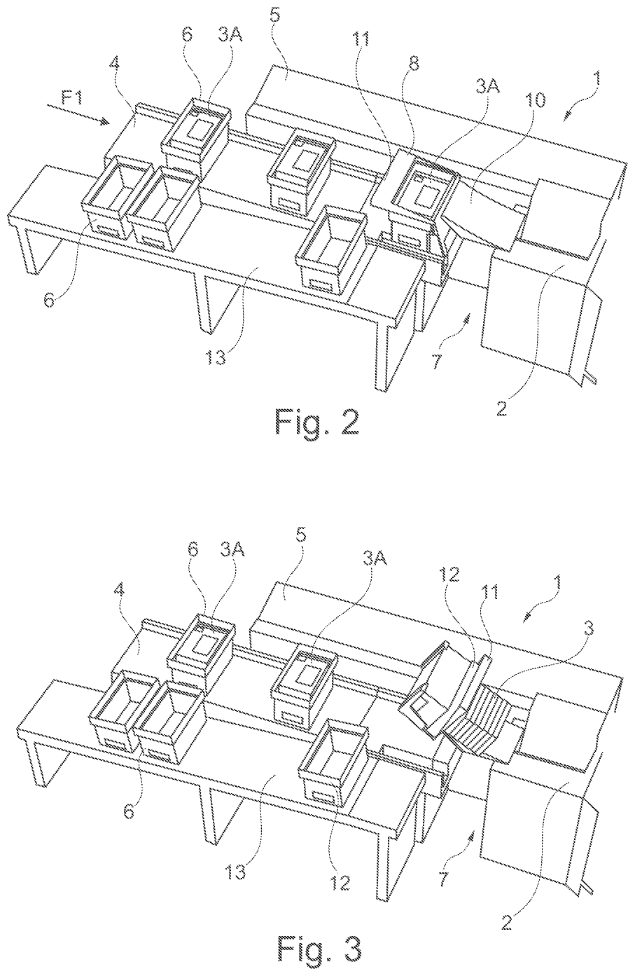

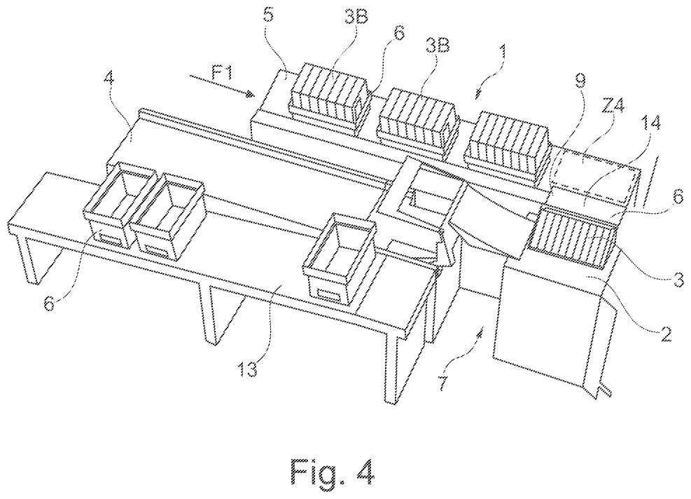

The means 8 and 9 are designed respectively to tip a tray loaded with mailpieces 3 laid flat 3A, as shown in FIGS. 2 and 3, and to tip a tray loaded with mailpieces stood on edge 3B, as shown in FIG. 4.

The tipping means 8 are designed to pivot a tray 6 forwards in the conveying direction F1 onto a ramp 10 of the tipping means.

The mailpieces 3 stored flat in the tray 6 are thus tipped and tilted on edge in the tray so as to be unloaded by sliding down to the unstacker magazine 2, as shown in FIGS. 2 and 3.

In this example, the ramp 10 of the tipping means is curved so that the sliding of the mailpieces 3 on edge is slowed down naturally.

The tray tipping-over means 9 are designed to lay a tray 6 over transversely to the conveying direction F1 onto the unstacker magazine 2.

The mailpieces 3 stored on edge in the tray 6 are thus tilted on edge onto another edge and slide from the tray 6 onto the unstacker magazine 2, as shown in FIG. 4.

Even though the two conveyors 4, 5 are designed for conveying all types of trays, the orientation of the mailpieces 3 in each tray 6 determines which conveyor should be used for conveying the tray.

Thus, the mailpieces that are stored flat in the trays are conveyed on the first conveyor 4 so as to be tipped by the tipping means 8 while the mailpieces 3 on edge in the trays are conveyed on the second conveyor 5 so as to be tipped by the tipping-over means 9.

The tipping means 8 are automated so that each tray 6 arriving at the downstream end of the first feed conveyor 4 is automatically tipped onto the unstacker magazine 2 into an unloading position.

The tipping means 8 comprise a rectangular yoke 11 designed to come to engage the top edges 12 of a tray 6 and to cause it to pivot via that one of said top edges that faces the unstacker magazine.

The pivoted tray 6 remains in the unloading position, as shown in FIG. 3, for a time that is predefined so as to enable the operative to retrieve the stack of mailpieces 3 that slides on edge onto the unstacker magazine 2.

Once the time in the unloading position has elapsed, the empty tray 6 is automatically pivoted in the reverse direction so as to be removed on a removal conveyor 13 of the apparatus of the invention.

The tray removal conveyor 13, shown in FIGS. 1 to 4, extends, in this example, along the first feed conveyor 4, 5 so as to facilitate removal of the trays 6, as empty of any mailpieces 3, from the unstacker magazine 2 to a tray storage zone Z3, shown in dashed lines in FIG. 1.

A new tray 6 loaded with mailpieces 3 then arrives at the end of the first conveyor 4 so as to be pivoted in turn, and so on.

The pitch between each tray 6 on the first conveyor 4 is thus determined as a function of the speed of conveying and as a function of the time for which each tray is tipped into the unloading position.

The tipping-over means 9 comprise a ramp 14 that extends transversely relative to the conveying direction F1 and that goes down from the second feed conveyor 5 to the unstacker magazine 2.

This ramp 14 makes it possible to cause a tray 6 to tip and slide transversely relative to the conveying direction F1.

The second tipping means 9 further comprise a blocking abutment 15 that is situated at the bottom of the ramp 14 and that is designed to prevent the base of a tray 6 from moving transversely on the ramp 14.

Thus, once the base of the tray is blocked, the operative merely has to pull the tray 6 towards him or her via the side facing him or her, while being assisted by the abutment that serves as a lever, thereby laying the tray 6 over onto the stacking magazine 2.

It can thus be understood that the laid-over tray 6 continues to bear against the abutment 15 so as to keep the tray in a tilted position in which it is tipped over onto the unstacker magazine 2 in order to facilitate unloading of the mailpieces 3 on edge.

The empty tray 6 is then retrieved by the operative and placed on the tray removal conveyor 13.

The ramps 10 and 14 are also on mutually intersecting paths and disposed on two adjacent sides of the stack reconstruction zone Z1 in which a stack of mailpieces on edge is reconstructed on said unstacker magazine.

This configuration of the ramps improves the working ergonomics for the operative.

Additionally, a portion Z4 of the second conveyor 5, shown in dashed lines in FIGS. 1 and 4, and adjacent to the ramp 14 is designed to convey the trays 6 towards the ramp 14 transversely to the conveying direction F1.

Naturally, the present invention is in no way limited to the above-described embodiment, which can undergo modifications without going beyond the ambit of the invention.

1. An apparatus for feeding an unstacker magazine with mailpieces on edge, comprising:
a first feed conveyor that extends to said unstacker magazine in a certain conveying direction and that is configured to convey trays extending crosswise and loaded with mailpieces placed flat on the bottoms of the trays;
tray tipping means interposed between said first feed conveyor and the unstacked magazine, configured to pivot a tray forwards in said conveying direction onto a ramp of the tray tipping means so as to bring the mailpieces on edge from the tray to the unstacker magazine;
a second feed conveyor that extends to said unstacker magazine and parallel to the first conveyor in said conveying direction and that is configured to convey trays extending lengthwise and loaded with mailpieces placed on edge on the bottoms of the trays; and
tray tipping-over means interposed between said second feed conveyor and said unstacker magazine and that are configured to lay a tray over on its side onto the unstacker magazine transversely to said conveying direction in such a manner as to bring the mailpieces on edge from the tray to the unstacker magazine, and in that said tipping-over means comprises a ramp on a path intersecting the path of the ramp of the tipping means, said ramps being disposed on two adjacent sides of a stack reconstruction zone in which a stack of mailpieces on edge is reconstructed on said unstacker magazine.

2. The apparatus according to claim 1, further comprising a tray removal conveyor for removing trays that extends along the first feed conveyor of said unstacker magazine.

3. The apparatus according to claim 2, wherein the second tipping means is provided with an abutment at the bottom of the ramp and configured to block the base of a tray and to provide leverage for laying a tray over onto said unstacker magazine.

4. The apparatus according to claim 1, wherein the second tipping means is provided with an abutment at the bottom of the ramp and configured to block the base of a tray and to provide leverage for laying a tray over onto said unstacker magazine.
